(19) United States
(12) Patent Application Publication
(10) Pub. No.: US 2002/0156796 A1
(43) Pub. Date: Oct. 24, 2002

(54) File conversion device

(75) Inventors: Yutaka Hisamatsu, Nagano-ken (JP); Masanori Mukaiyama, Nagano-ken (JP); Satoshi Miyazawa, Nagano-ken (JP)

Correspondence Address: OLIFF & BERRIDGE, PLC, P.O. BOX 19928, ALEXANDRIA, VA, 22320, US

(73) Assignee: SEIKO EPSON CORPORATION, Tokyo (JP)

(21) Appl. No.: 10/101,236

(22) Filed: Mar. 20, 2002

(30) Foreign Application Priority Data
Mar. 29, 2001 (JP) 2001-94510(P)

(51) Int. Cl. G06F 7/00; G06F 17/00; G06F 15/16; B41J 1/00; B41B 1/00; B41F 1/00; G06K 1/00; G06F 15/00

(52) U.S. Cl. 707/104.1; 707/101; 709/246; 358/1.15

(57) ABSTRACT

A constructed system includes multiple clients, a server like a print portal, and multiple printing stations connecting with the Internet. A client transmits an output requirement, which specifies a content of interest to be printed and a printing station selected as an output resource, to the print portal. The print portal, which works for mediation of printing, transmits the specified content of interest to the specified printing station. The print portal converts the content of interest into a PDF file by using information included in the output requirement as a password. The printing station specifies the password based on information included in the output requirement, decodes the PDF file, and actually performs a printing operation according to the decoded PDF file. Such encoding desirably enhances the security in the print mediation system via the Internet.

### BACKGROUND OF THE INVENTION

1. Field of the Invention

The present invention relates to a technique of mediating between a client and any of multiple output devices that output images or sound in a network, to which the client and the multiple output devices are connected, and thereby attaining output via the network.

2. Description of the Related Art

A variety of printers are used as an output device of computers. The printer is conventionally one-to-one connected to a computer via a specific cable like a two-way parallel interface (hereinafter referred to as ‘local connection’), and receives data from the computer to carry out printing. With recent advancement of LAN (Local Area Network), multiple printers connecting with a network share one or plural printers connected to the network.

Application of a certain protocol called IPP (Internet Printing Protocol) actualizes printing between an arbitrary client and an arbitrary printing apparatus, both connecting with the Internet. In this application, however, the output resource is restricted to printing apparatuses having known URIs (Uniform Resource Indicators). The simple application of IPP thus does not attain printing with the high utility that allows free choice of the output resource on the network.

In any of the known applications mentioned above, the state of connection of the printer with the computer is generally fixed. In other words, printing is typically carried out at a fixed location for each owner of the computer.

The recent development of the information infrastructure, such as the Internet, and the improvement in mobility of terminals used for access to the information infrastructure, such as mobile computers and cellular phones, enable access to information from any locations. In such circumstances, the technique of allowing free choice of the output resource for printing on the network has highly been demanded. One desired procedure uses a closest printing apparatus to carry out printing immediately after collection of information to be printed. Such a printing requirement should readily be executable from any mobile terminal.

High security is required in the system of allowing the user to freely select a desired output resource on the network. In order to ensure successful printing via the network, it is highly demanded to prevent illegal browsing, use, and modification of mediated print data by any unauthorized third person.

According to one known method, the user may set an arbitrary password to print data, in order to ensure the security. This method, however, requires individual transmission of the password to a system that mediates print data and each output device. This undesirably damages the smoothness of printing via the network.

Such requirement is not restricted to printing but is commonly found in the general process of outputting images and sound via a network.

### SUMMARY OF THE INVENTION

The object of the present invention is thus to provide a technique that enhances security in the process of outputting images and sound via a network.

In order to attain at least part of the above and the other related objects, the present invention is directed to a file conversion device that is interposed between a client and each of multiple output devices in a network, to which the client and the multiple output devices are connected.

Each of the multiple output devices outputs either images or sound. Printing apparatuses, projectors, displays, and audio equipment that are connectable with the network are typical examples of such output devices. Only one identical type of output devices or multiple different types of output devices may be connected to the network.

The file conversion device generates a transfer file, which is to be transferred to the output device, in response to an instruction sent from the client, and includes an input module, a file conversion module, and a transmission module. The input module receives input of a master image and/or sound file according to the instruction sent from the client. The transmission module transmits the transfer file onto the network. The transfer file may be transferred to the output device directly or via a predetermined server.

The file conversion module converts the master image and/or sound file into the transfer file of a predetermined format, which does not depend upon the output device. More specifically, the file conversion module carries out encoding with intrinsic information mapped to at least part of the instruction sent from the client in this conversion process. In the case of an output via the network, the instruction sent from the client generally includes information specifying a user who requires the output, data of interest to be output, and a selected output resource. The technique of the present invention carries out encoding with the information mapped to at least part of such information. The intrinsic information does not mean information arbitrarily set by the user, but represents information defined corresponding to the relation to the output requirement. The procedure of the present invention utilizes the intrinsic information for encoding and accordingly does not require individual transmission of any password used for encoding in an explicit manner. This arrangement thus enhances security in the process of mediating the transfer file, while ensuring the smoothness of outputting images or sound via the network.

The technique of the present invention utilizes the predetermined format, which does not depend upon the output device, and thereby heightens the degree of freedom in selection of the output resource. For example, in the case where a printer is used as the output device, the predetermined format may not be a control signal intrinsic to the printer (hereinafter referred to as raw data) but may be a general purpose page description language. One typical example of the general purpose format is a PDF format, although another page description language like Postscript (registered trademark) is also usable. Such a format advantageously enables the layout of a master print to be kept relatively easily, and is capable of converting substantially any print data. The technique of the present invention is thus effectively applicable to a wide range of print data.

A diversity of arrangements are applicable for the intrinsic information used for encoding. The intrinsic information may be information mapped to an output device specified by the client, to the client, to a user information specifying a user who gives the instruction from the client, or to the master image and/or sound file. The information mapped to the output device or the client may be location information for specifying location of the output device or the client on the network, for example, address information or a URI (Uniform Resource Indicator). The information mapped to the user information is, for example, a user ID used for execution of the output. The information mapped to the master image and/or sound file is, for example, the name of the file or location information of the file like its URL (Uniform Resource Locator).

A diversity of methods are applicable for encoding carried out by the file conversion module. In one preferable application, encoding is carried out to make the intrinsic information function as key data required for decoding the transfer file. The key data may be a combination of multiple pieces of information.

In another preferable application of the present invention, encoding is carried out to be kept from at least the user who gives the instruction. More specifically, the encoding is closed in the system that outputs images or sound via the network. The password arbitrarily set by the user is decodable rather easily and does not ensure sufficient security. The closed encoding is, on the other hand, not readily opened to outside and advantageously ensures sufficient security. Since the user is not involved in the encoding process, information used for encoding, such as the password, may be complicated to be undecodable in a practical time period.

The encoding kept from the user includes both an application of keeping the fact of encoding from the user and an application of keeping the information used for encoding from the user.

The file conversion module may carry out the encoding, which is to be kept from the user, with intrinsic information commonly set by the file conversion module and a decoding device that decodes the transfer file. The decoding device may be incorporated in the output device or provided separately from the output device. The intrinsic information may be any of diverse information that is shared by the file conversion module and the decoding device without any explicit transmission there between. For example, the intrinsic information is any of various pieces of information included in the output requirement sent from the client. In another example, the intrinsic information is a preset piece of information commonly specified in advance by the file conversion module and the decoding device, independently of the output requirement.

The present invention is also directed to a decoding device that decodes the transfer file prior to transmission to the output device, as a sub-combination of the file conversion device. The decoding device receives input of the intrinsic information required for decoding the encoded transfer file and carries out decoding with the input intrinsic information. In the case where the intrinsic information is related to the output requirement, the decoding device analyzes the received output requirement and specifies the intrinsic information. When the intrinsic information is the information mapped to either the user or the file, an input interface may be provided to input the intrinsic information to the decoding device.

The technique of the present invention is not restricted to the applications of the file conversion device and the decoding device, but may be actualized by a diversity of other applications, such as corresponding file conversion method, encoding method, and decoding method. The other applications also include computer programs that cause the computer to attain the file conversion, encoding, and decoding, a diversity of signals equivalent to the computer programs, and recording media in which such computer programs are recorded.

Typical examples of the recording media include flexible disks, CD-ROMs, magneto-optic discs, IC cards, ROM cartridges, punched cards, prints with barcodes or other codes printed thereon, internal storage devices (memories like a RAM and a ROM) and external storage devices of the computer, and a variety of other computer readable media.

These and other objects, features, aspects, and advantages of the present invention will become more apparent from the following detailed description of the preferred embodiment with the accompanying drawings.

### BRIEF DESCRIPTION OF THE DRAWINGS

FIG. 1 illustrates the general architecture of a printing system;

FIG. 2 shows flow of data in the process of printing E mails;

FIG. 3 is a time chart in the process of printing E mails;

FIG. 4 shows an exemplified interface in the process of printing E mails;

FIG. 5 shows functional blocks of a print portal;

FIG. 6 illustrates the internal structure of a core module 130;

FIG. 7 shows details of a file conversion process; and

FIG. 8 shows variations in timing of file conversion.

### DESCRIPTION OF THE PREFERRED EMBODIMENTS

One mode of carrying out the present invention is discussed below as a preferred embodiment of a printing system via a network.

A. Basic System Architecture

A1. Overview of System

A2. Functionality

A3. Configuration of Functional Blocks

B. File Conversion

C. Effects

D1. Modification (1)

D2. Modification (2)

D3. Modification (3)

D4. Modification (4)

A. Basic System Architecture

A1. Overview of System

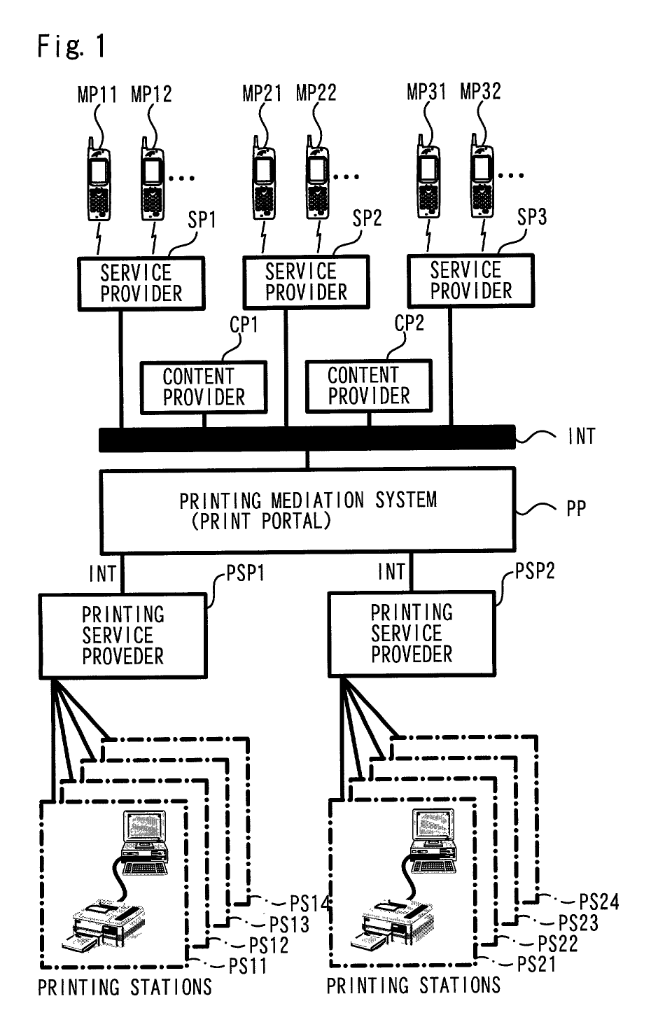

FIG. 1 illustrates the general architecture of a printing system. This embodiment regards the system that executes printing via the Internet. The similar architecture may be applicable to relatively limited network environments, such as LAN (Local Area Network) and computer communication.

In the system of this embodiment, a diversity of servers and clients are connected to the Internet INT. For convenience of explanation, the connection is shown in a hierarchical manner, but the respective constituents enable mutual transmission of information via the Internet INT. For clarity of illustration and explanation, only a limited number of constituents are shown, although there is no limit of in number of connections. The technique of the embodiment executes a printing operation with an arbitrary printer under the system architecture including a large number of servers and clients connected with one another via the Internet INT.

This embodiment uses, as the clients, mobile phones MP11, MP12, MP21, MP22, MP31, MP32 having the access functionality to the Internet. Each of these mobile phones, for example, MP11 gains access to the Internet via any of service providers SP1, SP2, and SP3. The clients are not restricted to the mobile phones but may be personal computers.

Content providers CP1 and CP2 are also connected to the Internet INT. In the system of this embodiment, these content providers, for example, CP1, provide contents to be printed. The content providers include Web page providers on the Internet INT.

In the system of this embodiment, printing stations, for example, PS11, are output resources. The printing stations like PS11 represent printers that enable transmission of data via the Internet. The printing station is constructed, for example, by combining a computer connected to the Internet with a printer locally connected to the computer. The printing stations may be located in rather private spaces with relatively limited users like individual houses and offices or in rather public spaces like stores and hotels.

In the system of this embodiment, in response to an instruction from the client MP11, contents provided by the content provider CP1 are transmitted to the printing station, which executes an actual printing operation. Two different-layered servers, that is, upper-layer and lower-layer servers, mediate data between the clients and the printing stations.

In the illustrated example, the upper-layer server is a printing mediation system (print portal) PP, and the lower-layer servers are printing service providers PSP1 and PSP2.

The lower-layer servers, such as the printing service provider PSP1, function to manage the printing stations like PS11. In the illustrated example, the printing service provider PSP1 manages printing stations PS11 to PS14, whereas the printing service provider PSP2 manages printing stations PS21 to PS24. In the case where the printing stations like PS11 are located in individual stores, for example, the respective printing service providers PSP1 may be owned by different business proprietors. A business proprietor A owns the printing service provider PSP1 and manages the printing stations PS11 to PS14 located in its head quarter and branch shops. A business proprietor B owns the printing service provider PSP2 and manages the printing stations PS21 to PS24. Such arrangement enables each business proprietor to manage its own printing stations and supply unique services relating to the mediation of print data, for example, discount service.

The upper-layer server, that is, the print portal PP, manages the printing service providers PSP1 and PSP2. The print portal PP thus indirectly manages the printing stations like PS11 via the printing service providers PSP1 and PSP2. The upper-layer server provides common functionality even when the printing service providers PS1 and PS2 are run by the different business proprietors. For example, the upper-layer server provides a standard interface in response to a print request from the client MP11. This desirably enhances the utility of the users.

The upper-layer server and the lower-layer server are functionally parted from each other, and each server may not be constructed as a single server. The functionality of the upper-layer server and the lower-layer server discussed below may be distributed into multiple servers.

A2. Functionality

The internal structure of each constituent included in the system of the embodiment will be discussed later. In order to elucidate the functionality of the servers and the other constituents, the following description regards a concrete example of printing E mails utilizing the print portal.

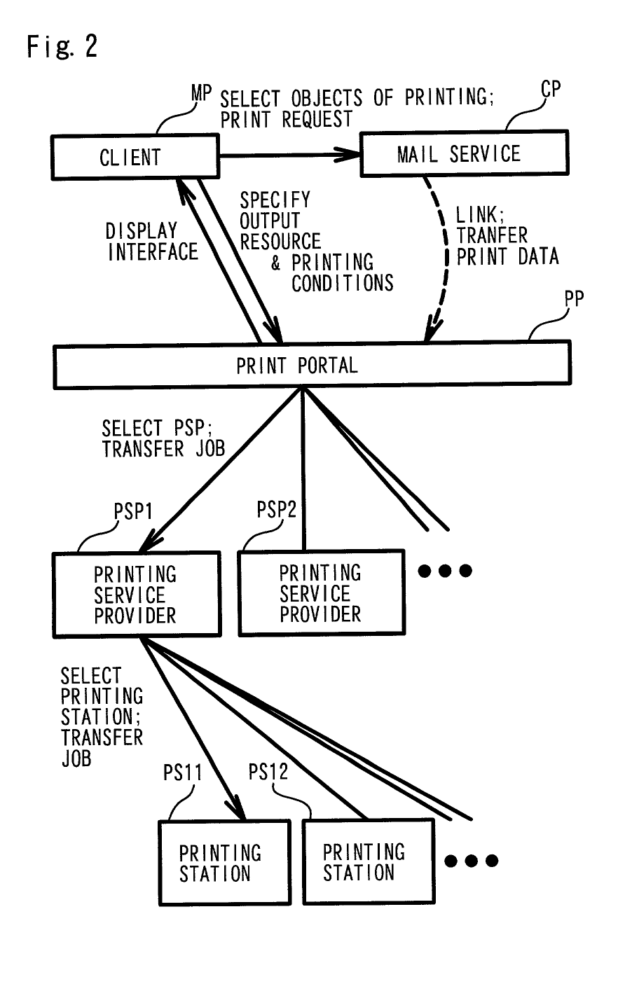

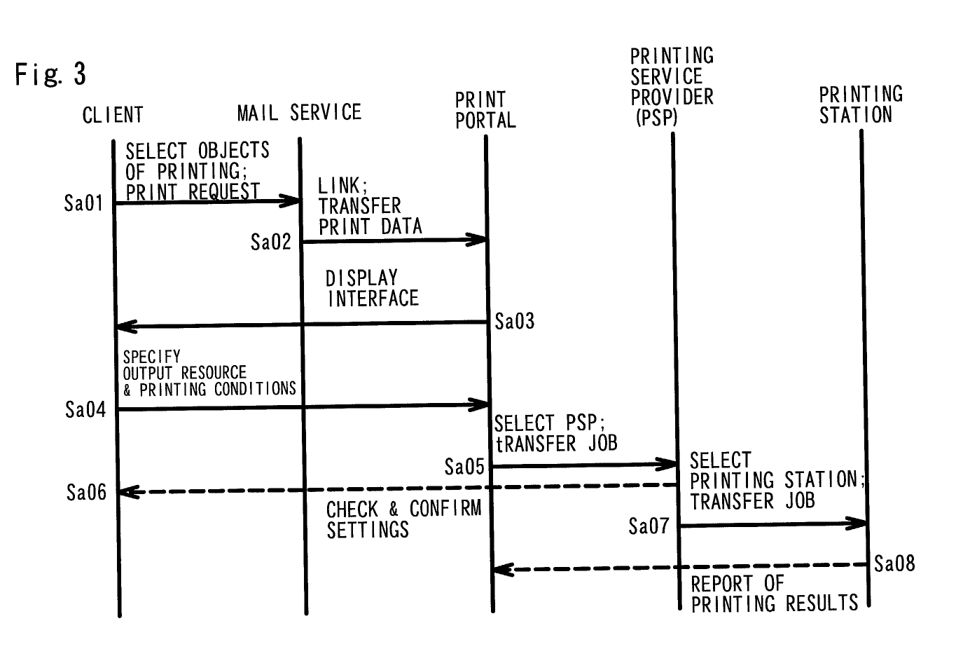

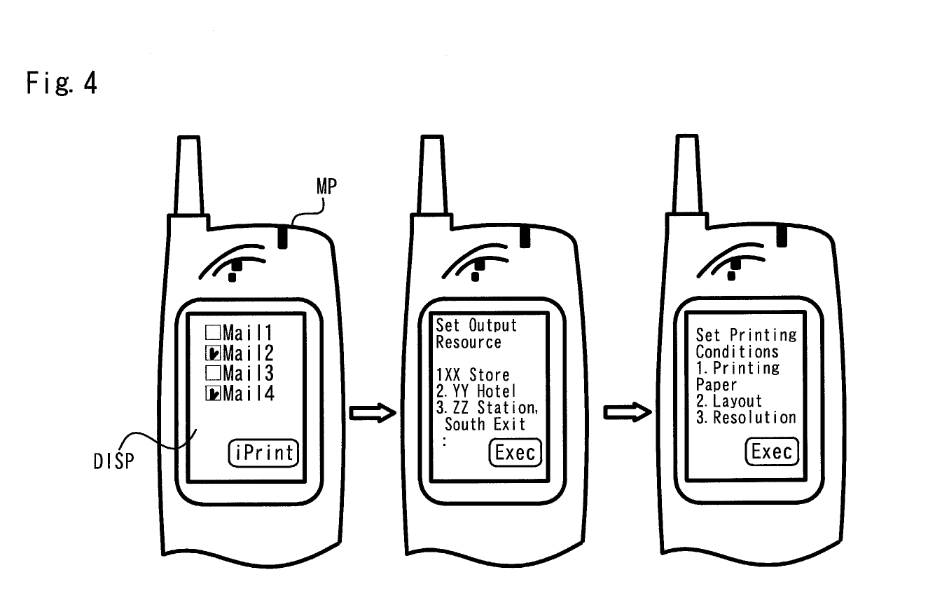

FIG. 2 shows flow of data in the process of printing E mails. FIG. 3 is a time chart in the process of printing E mails. FIG. 4 shows an exemplified interface in the process of printing E mails. The functionality of the respective units is discussed with referring to these drawings. In the case of E mails, a mail service CP corresponds to a content provider.

The user first gains access from a client MP to the mail service CP, checks E mails addressed to the user, and selects one or plural mails to be printed. A series of interface windows appearing on a display unit DISP of the mobile phone is shown in FIG. 4. The left-side window shows that there are four mails Mail 1 to Mail 4 addressed to the user and that Mail 2 and Mail 4 have been selected as objects of printing. This interface is provided by the mail service CP. When the user presses a button ‘iPrint’ on the window, a requirement for execution of printing is transmitted from the mail service CP to the print portal PP (see Sa01 in FIGS. 3 and 2).

When the mail service CP is registered in advance as a content provider in the print portal PP, the button ‘iPrint’ appears on the window. This button functions as a link to the print portal PP. In response to the requirement for printing by a press of the ‘iPrint’ button, the destination of access by the client MP is changed to the print portal PP. Print data, that is, data of Mail 2 and Mail 4, is then transmitted from the mail service CP to the print portal PP (see Sa02 in FIGS. 3 and 2).

The print portal PP subsequently provides the client MP with interfaces for specifying the output resource and printing conditions (see Sa03 in FIGS. 3 and 2).

The center drawing of FIG. 4 shows an interface window for designating the output resource. Available printing stations are enumerated for the designation of the output resource. The list of the available output resources may be displayed in a hierarchical manner. For example, when the user selects ‘XX Store’ in the list shown in FIG. 4, all shops belonging to the XX Store chain are enumerated. One modified procedure may cause the user to select one among available printing service providers on the first stage of the hierarchical designation.

The right-side drawing of FIG. 4 shows an interface window for specifying the printing conditions. Typical examples of the printing conditions include the paper size, the layout, and the resolution. Selection of a ‘Printing Paper’ menu enables the detailed settings for the printing paper, for example, the size A4 or B5. Selection of a ‘Layout’ menu enables the detailed settings for the layout, for example, 1 page/sheet or 2 pages/sheet. Selection of other menus enables the detailed settings for other printing conditions. The settings of printing are not restricted to this example, but a diversity of fields may be provided by taking into account the utility.

When the user completes the specification of the output resource and the printing conditions with the above interface, the specified information is transmitted to the print portal PP (see Sa04 in FIGS. 3 and 2). The print portal PP selects the printing service provider PSP1 as the destination of transmission of a print job, based on the received information, and transfers the print job to the selected printing service provider PSP1 (see Sa05 in FIGS. 3 and 2). Here the printing service provider PSP1, which manages the printing station PS11 designated by the user as the output resource, is selected as the destination of transmission of the print job.

The printing service provider PSP1 that has received the print job selects the printing station PS11 and transfers the print job to the selected printing station PS11 (see Sa07 in FIGS. 3 and 2). Here the printing station PS11 designated by the user is selected as the destination of transmission.

The print data is converted to a PDF file, which is a general purpose format, in the course of mediation with the print portal PP and the printing service provider PSP1. The PDF file is generated as an encoded file using a preset password for enhanced security in the process of printing mediation. The details of the file conversion process will be discussed later. The printing station PS11 analyzes the PDF file and executes a printing operation.

As shown by Sa06 in FIG. 3, a display including the designated output resource and the specified printing conditions may be given to the client MP for the purpose of check and confirmation, prior to the transfer of the print job from the printing service provider PSP1 to the printing station PS11.

On completion of the printing operation, a report of printing results may be transmitted from the printing station PS11 to the print portal PP. The print portal PP detects the normal completion of the printing operation based on the report, and carries out post services like accounting.

The above example mediates printing with the two different layered servers, that is, the print portal PP as the upper-layer server and the printing service providers like PSP1 as the lower-layer servers. The use of the two-layered servers for the mediation has advantages discussed below.

The lower-layer server may be organized by each business line, in order to provide unique services characteristic of the business line and allow discrimination from other business proprietors. Each business proprietor can rather readily take in the users and the content providers registered with the print portal PP as the potential customers of its business line.

Even when the lower-layer servers are individually organized by different business lines, the upper-layer server provides the users with a standard interface. This enhances the utility of the print portal.

The user who has been registered with the print portal PP can readily utilize a diversity of lower-layer servers under the control of the print portal PP. This arrangement does not require time-consuming, complicated registration and other related work for each lower-layer server, thus enhancing the utility. The content providers share such advantages. The content provider that has been registered with the print portal PP can readily increase in number the users and the output resources of the offered contents.

The printing mediation system is not restricted to the construction utilizing the two-layered servers, but may be organized by a single-layer server configuration having the combined functions of the print portal and the printing service providers.

A3. Configuration of Functional Blocks

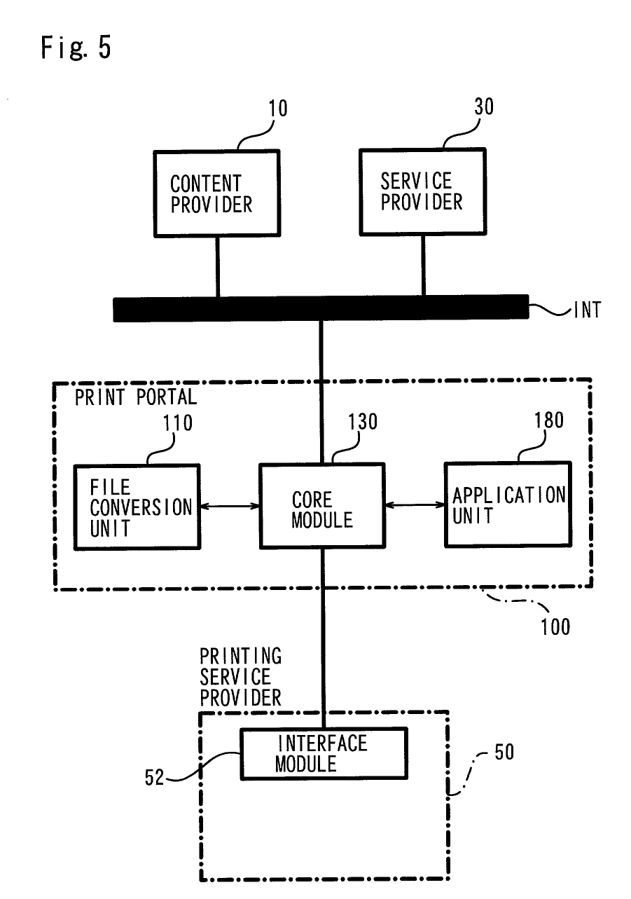

FIG. 5 shows functional blocks of the print portal. For convenience of explanation, the respective constituents are expressed by numbers different from the symbols of FIG. 1, although the constituents of the identical names have the same functions.

As illustrated, a print portal 100 mainly includes three functional blocks, a core module 130, a file conversion unit 110, and an application unit 180. In this embodiment, these functional blocks are attained by the software.

The file conversion unit 110 converts the format of print data to a predetermined intermediate file in the course of mediation of the print data. The PDF is used as the general purpose format in this embodiment.

The application unit 180 executes the main functions of the print portal 100 to mediate the print data and a diversity of additional functions.

The core module 130 cooperates with the file conversion unit 110 and the application unit 180 to mediate the print data. The core module 130 takes charge of communication with a content provider 10, a service provider 30, and a printing service provider 50. The printing service provider 50 has an interface module 52 to ensure the flexibility of a protocol in connection with the print portal 100.

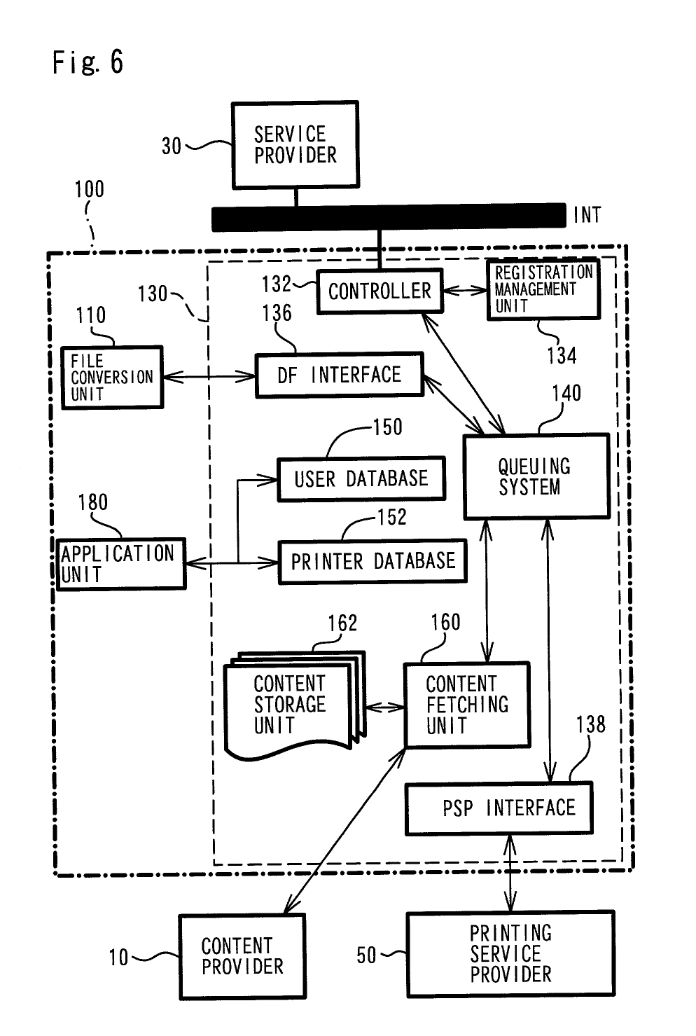

FIG. 6 illustrates the internal structure of the core module 130. This internal structure is only illustrative, and the core module 130 may have any of other diverse constructions.

A controller 132 controls the operations of the respective functional blocks of the print portal 100 and transmission of information to and from the outside via the internet INT. The control includes registration and management of users and providers, control of the status of print jobs, acceptance and cancellation of print requests, and retrieval of printers as the output resource. The controller 132 also provides an interface window to allow transmission of data between the print portal 100 and the outside.

A registration management unit 134 takes charge of registration and management of the user utilizing the print portal 100, the content provider 10, and the printing service provider 50. The registration management unit 134 creates an interface window for the registration and management and stores and updates registration-related data in a predetermined data base.

A queuing system 140 relays the operations of the respective functional blocks. In this embodiment, the respective functional blocks are constructed by the object-oriented software. Each functional block refers to a message registered in the queuing system 140, detects the presence of a job to be processed, and executes the actual processing. On completion of the processing, a message representing conclusion of the processing is registered in the queuing system 140. The respective functional blocks execute the processing with the queuing system 140 as the relay. The print portal 100 accordingly actualizes a series of processing, from acceptance of a print request to completion of a printing operation.

In order to attain the series of processing, the queuing system 140 has a content fetching queue, a file conversion queue, a job sending queue, and a job canceling queue.

A content fetching unit 160 gains access to the content provider 10 and fetches a content specified by the user as an object of printing. The fetched content is temporarily stored in a content storage unit 162. The content fetching unit 160 refers to the content fetching queue provided in the queuing system 140 and performs the above operation according to the message accumulated in the content fetching queue. After fetching the content, the content fetching unit 160 registers a message to require file conversion of the content in the fine conversion queue provided in the queuing system 140.

The file conversion unit 110 functions to convert the content to the PDF format. Encoding with a preset password is also performed in this conversion process. Even when the content is a PDF file, the file conversion unit 110 carries out encoding and reconversion to the PDF format. The PDF is the general purpose format. Conversion of the print data to this format advantageously enables output of the print data to a diversity of printers. Another advantage is relatively accurate reproduction of the selected layout in prints. The PDF allows conversion from practically any print data including documents and pictures, so that a wide range of contents can be the object of printing. A page description language, such as Postscript (registered trademark), may alternatively be used as the general purpose format.

In the structure of this embodiment, with a view to relieving the load applied to each server, the file conversion unit 110 is constructed as a separate server from the core module 130. The core module 130 accordingly has a DF interface 136 to allow transmission of data to and from the file conversion unit 110.

The DF interface 136 transfers data to the file conversion unit 110, in response to the message accumulated in the file conversion queue provided in the queuing system 140. When receiving a processed PDF file from the file conversion unit 110, the DF interface 136 registers a message of print job transmission in the job sending queue provided in the queuing system 140. One possible modification omits the DF interface 136 and constructs the file conversion unit 110 to gain direct access to the queuing system 140.

A PSP interface 138 functions to transmit a print job to the printing service provider 50. More specifically, the PSP interface 138 transmits a print job to the designated printing service provider 50, in response to the message accumulated in the job sending queue provided in the queuing system 140. The PSP interface 138 also sends a message of job cancellation accumulated in the job canceling queue. The transmission is attained according to a diversity of protocols set by the printing service provider 50, for example, HTTP (Hypertext Transport Protocol).

The core module 130 includes a diversity of databases, such as a user database 150 and a printer database 152. Although only two databases are illustrated in this embodiment, a greater number of databases may be provided in the core module 130. The registration management unit 134 manages these databases. The databases are utilized for the processing executed in the core module 130, as well as for the processing executed by the application unit 180.

The user database 150 includes files provided for the respective users of the print portal 100. Each file stores user-related attribute information, for example, the user name and the user ID. The printer database 152 has registration of attribute information with regard to the respective printers, for example, the printer name and the ID number. The ID number represents an index utilized to identify the printer in the printing process with the print portal 100.

The system of the embodiment having the construction discussed above carries out the printing process discussed above with reference to FIGS. 2 through 4.

B. File Conversion

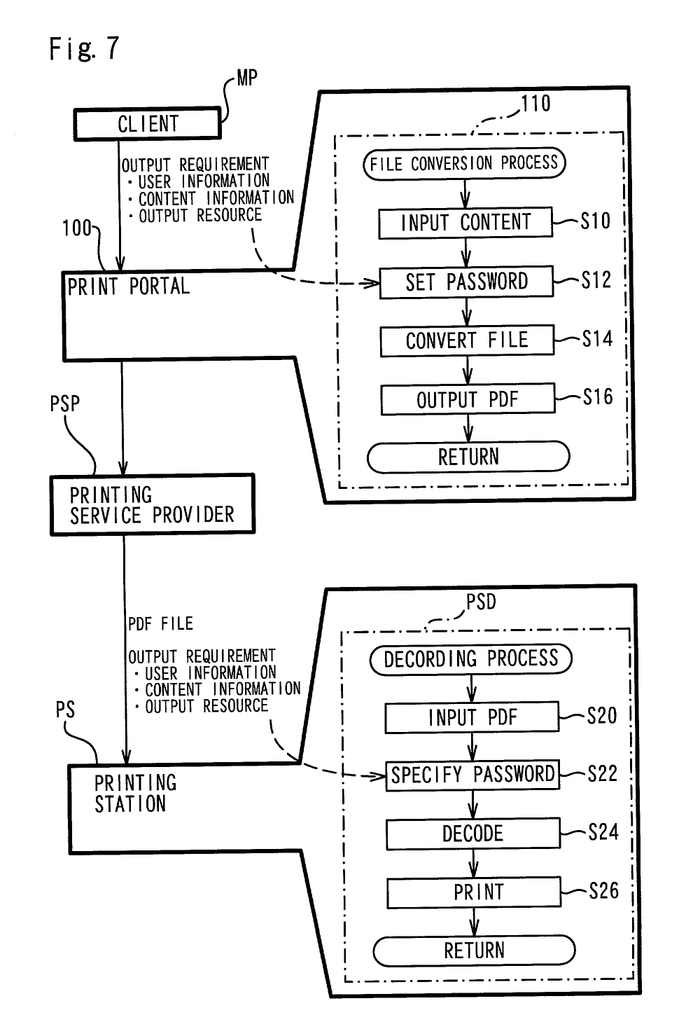

The following describes conversion to a PDF file executed by the file conversion unit 110. FIG. 7 shows details of the file conversion process. In response to an instruction sent from the client MP, a content of interest is mediated by the print portal 100 and the printing service provider PSP and is printed by the printing station PS.

The file conversion process is carried out by the file conversion unit 110 in the print portal 100 as mentioned previously. A flowchart of the file conversion process is shown in FIG. 7.

On a start of the file conversion process, the file conversion unit 110 first inputs a content of interest, which is to be converted, at step S10, and sets a password used for encoding, which is carried out in the course of file conversion, at step S12. In the arrangement of this embodiment, the password is set by utilizing information included in an output requirement sent from the client MP.

The output requirement includes information for specifying the user, information for specifying the content of interest to be printed, and information for specifying the printing station as the output resource. At least part of such pieces of information is transmitted, together with the content of interest, to the printing station. The procedure of this embodiment sets the password with the information transmitted to the printing station.

The information transmitted to the printing station may be location information for specifying the printing station PS, the printing service provider PSP, or the client MP on the network, for example, address information or a URI (Uniform Resource Indicator). The information transmitted to the printing station may otherwise be information mapped to the user, for example, a user ID, or location information mapped to the content of interest, for example, the file name of the content or a URL (Uniform Resource Locator). These pieces of information may be used in combination.

The file conversion unit 110 carries out file conversion to the PDF format with the password set in the above manner at step S14. Encoding is also performed with the password set at step S12. Because of the necessity of encoding, the file conversion unit 110 carries out the processing of step S14 even when the input content of interest is a PDF file. The file conversion unit 110 outputs the resulting converted PDF file at step S16 and concludes the file conversion process.

The PDF file thus generated is transferred together with the output requirement to the printing station PS via the printing service provider PSP. The printing station decodes the transferred PDF file and implements the actual printing operation. More specifically, this process is executed by a decoding process unit PSD, which is provided as a functional block of the software configuration in the printing station PS. A flowchart of the decoding process executed by the decoding process unit PSD is also illustrated in FIG. 7.

On a start of the decoding process, the decoding process unit PSD inputs the PDF file at step S20 and specifies the password used for encoding at step S22. The procedure of this embodiment sets the password with the information included in the output requirement. The decoding process unit PSD accordingly specifies the password, based on the information included in the transmitted output requirement. The method of specifying the password based on the information included in the output requirement has been determined in advance by the print portal 100 and the printing station PS.

The decoding process unit PSD decodes the PDF file with the password set in the above manner at step S24 and carries out the actual printing operation at step S26.

C. Effects

The printing system of this embodiment discussed above encodes the content and mediates the encoded content in the printing process via the network, thus enhancing the security. The information included in the output requirement is used for encoding. There is accordingly no necessity of explicitly transmitting any password to the printing service provider PSP or the printing station PS. The technique of this embodiment thus enhances the security without damaging the smoothness of printing via the network.

The printing system of this embodiment carries out encoding with the information included in the output requirement. This arrangement advantageously changes the password for each output requirement, thus enhancing the security, compared with the prior art technique that utilizes fixed information, such as a public key or a common key shared in secrecy by the transmitter and the receiver.

The technique of this embodiment does not require the user to set the password in the course of executing the printing operation. This allows the user to carry out printing without specific recognition of encoding the content. From this point of view, the technique of this embodiment performs encoding that is kept from the user. The encoding kept from the user desirably prevents the password from being opened by the careless user. This arrangement thus enhances the security. The user is not involved in setting the password, so that even an extremely complicated setting of the password is allowable. This further enhances the security.

D1. Modification (1)

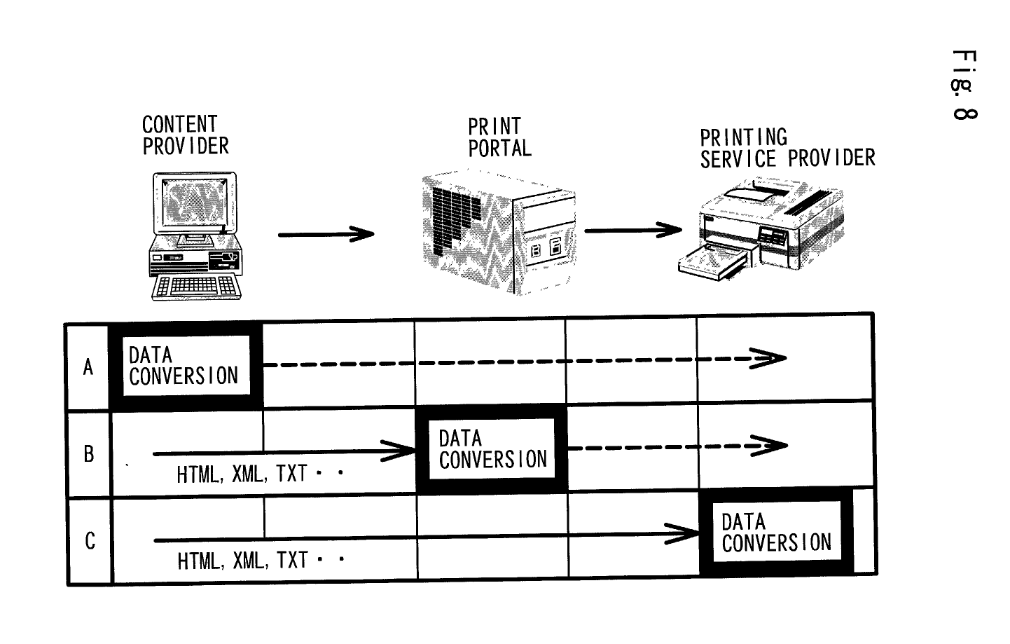

In the configuration of this embodiment, the file conversion unit 110 is incorporated in the print portal 100. The file conversion unit 110 may function in any of diverse phases of print data mediation. FIG. 8 shows variations in timing of file conversion.

Three cases, Case A to Case C, are shown here. For convenience of explanation, master data prior to file conversion is called ‘content’, and converted data after file conversion is called ‘PDF data’.

In Case A, the content provider carries out file conversion. When the user sends a self-made document from the client to the print portal, the client simultaneously corresponds to the content provider. In Case A, the content provider outputs data in the form of a PDF file. Neither the print portal nor the printing service provider is required to carry out the file conversion.

In Case B, the print portal carries out file conversion. This corresponds to description of the above embodiment. The content transmitted to the print portal in Case B may follow any of diverse formats, for example, HTML, XML, text file, or JPEG. The data output from the print portal to the printing service provider are unified to the PDF file.

In Case C, the printing service provider carries out file conversion. Data of various formats are supplied from the content provider to the printing service provider via the print portal, and are unified to the PDF file immediately before transmission to the printing station. As the printing service provider is individually organized by each business proprietor, the business proprietor may individually select the format generated by the file conversion.

The decoding process, which is carried out by the printing station in the above embodiment, may alternatively be executed by the printing service provider PSP.

D2. Modification (2)

The procedure of the above embodiment sets the password with the information included in the output requirement. Setting the password is, however, not restricted to this procedure, but the password may be set independently of the output requirement. In the latter case, the procedure utilizes any of various passwords commonly recognizable by the file conversion unit 110 and the decoding process unit PSD. The password may be set and stored in advance commonly by the file conversion unit 110 and the decoding process unit PSD. Another applicable procedure produces a password according to a certain rule, for example, based on dates of encoding and decoding. In any of these methods, it is preferable to carry out encoding and keep the details of encoding from the user.

D3. Modification (3)

The procedure of the above embodiment sets the password, based on the information transmitted to the printing station PS. The information used for setting the password is, however, not restricted to the information transmitted via the network, as long as the information is shared by the file conversion unit 110 and the decoding process unit PSD. The information used for setting the password may be information, such as a user ID, input by the user with an input panel provided in the printing station PS in the printing process.

D4. Modification (4)

The embodiment regards the printing system via the network. The technique of the present invention is applicable to diverse systems that output images or sound via the network. The output device may be any of projectors, displays, and audio equipment that are connectable to the network. The general purpose format applied for the file conversion is selectable corresponding to the type of the output device. Plural different types of these output devices may be connected to the network.

The above embodiment and its modifications are to be considered in all aspects as illustrative and not restrictive. There may be many modifications, changes, and alterations without departing from the scope or spirit of the main characteristics of the present invention. All changes within the meaning and range of equivalency of the claims are therefore intended to be embraced therein.

The scope and spirit of the present invention are indicated by the appended claims, rather than by the foregoing description.

What is claimed is:

1. In a network connecting with a client and multiple output devices, each outputting either one of an image and sound, a file conversion device that is interposed between said client and each of said multiple output devices and generates a transfer file, which is to be transferred to said output device, in response to an instruction sent from said client, said file conversion device comprising:
an input module that receives input of a master image and/or sound file according to the instruction sent from said client;
a file conversion module that converts the master image and/or sound file into the transfer file of a predetermined format, which does not depend upon said output device; and
a transmission module that transmits the transfer file onto the network,
wherein said file conversion module carries out encoding with intrinsic information mapped to at least part of the instruction sent from said client in the conversion process.

2. A file conversion device in accordance with claim 1, wherein said output device prints an image, and the predetermined format is a general purpose page description language.

3. A file conversion device in accordance with claim 2, wherein the predetermined format is a PDF format.

4. A file conversion device in accordance with claim 1, wherein the intrinsic information is mapped to an output device specified by said client.

5. A file conversion device in accordance with claim 1, wherein the intrinsic information is mapped to said client.

6. A file conversion device in accordance with claim 1, wherein the intrinsic information is mapped to a user information specifying a user who gives the instruction from said client.

7. A file conversion device in accordance with claim 1, wherein the intrinsic information is mapped to the master image and/or sound file.

8. A file conversion device in accordance with claim 1, wherein said file conversion module carries out encoding to make the intrinsic information function as key data required for decoding the transfer file.

9. In a network connecting with a client and multiple output devices, each outputting either one of an image and sound, a file conversion device that is interposed between said client and each of said multiple output devices and generates a transfer file, which is to be transferred to said output device, in response to an instruction sent from said client, said file conversion device comprising:
an input module that receives input of a master image and/or sound file according to the instruction sent from said client;
a file conversion module that converts the master image and/or sound file into the transfer file of a predetermined format, which does not depend upon said output device; and
a transmission module that transmits the transfer file onto the network,
wherein said file conversion module carries out encoding, which is kept from at least a user who gives the instruction, in the conversion process.

10. A file conversion device in accordance with claim 9, wherein a decoding device that decodes the transfer file is further connected to the network, and
said file conversion module carries out encoding with intrinsic information commonly set by said decoding device and said file conversion module.

11. A file conversion device in accordance with claim 10, wherein said file conversion module carries out encoding to make the intrinsic information function as key data required for decoding the transfer file.

12. In a network connecting with a client, multiple output devices, each outputting either one of an image and sound, and a file conversion device that is interposed between said client and each of said multiple output devices and generates a transfer file, which is encoded and transferred to said output device, in response to an instruction sent from said client, a decoding device that decodes the transfer file prior to transmission to said output device,
wherein encoding is carried out with intrinsic information mapped to at least part of the instruction sent from said client,
said decoding device comprising:
an information input module that receives input of the intrinsic information; and
a decoding process module that carries out decoding with the input intrinsic information.

13. In a network connecting with a client and multiple output devices, each outputting either one of an image and sound, a file conversion method that generates a transfer file, which is to be transferred to said output device, in response to an instruction sent from said client, said file conversion method comprising:
(a) receiving input of a master image and/or sound file according to the instruction sent from said client;
(b) converting the master image and/or sound file into the transfer file of a predetermined format, which does not depend upon said output device; and
(c) transmitting the transfer file onto the network,
wherein said step (b) carries out encoding with intrinsic information mapped to at least part of the instruction sent from said client in the conversion process.

14. In a network connecting with a client and multiple output devices, each outputting either one of an image and sound, a file conversion method that generates a transfer file, which is to be transferred to said output device, in response to an instruction sent from said client, said file conversion method comprising:
(a) receiving input of a master image and/or sound file according to the instruction sent from said client;
(b) converting the master image and/or sound file into the transfer file of a predetermined format, which does not depend upon said output device; and
(c) transmitting the transfer file onto the network,
wherein said step (b) carries out encoding, which is kept from at least a user who gives the instruction, in the conversion process.

15. In a network connecting with a client, multiple output devices, each outputting either one of an image and sound, and a file conversion device that is interposed between said client and each of said multiple output devices and generates a transfer file, which is encoded and transferred to said output device, in response to an instruction sent from said client, a decoding method that decodes the transfer file prior to transmission to said output device,
wherein encoding is carried out with intrinsic information mapped to at least part of the instruction sent from said client,
said decoding method comprising the steps of:
receiving input of the intrinsic information; and
carrying out decoding with the input intrinsic information.

16. A computer readable recording medium in which a computer program is recorded, said computer program causing a computer to generate a transfer file, which is to be transferred to an output device, in response to an instruction sent from a client, in a network connecting with said computer, the client and multiple output devices, said computer program causing the computer to attain the functions of:
receiving input of a master image and/or sound file according to the instruction sent from said client; and
converting the master image and/or sound file into the transfer file of a predetermined format, which does not depend upon said output device and carrying out encoding with intrinsic information mapped to at least part of the instruction sent from said client in the conversion process.

17. A computer readable recording medium in which a computer program is recorded, said computer program causing a computer to generate a transfer file, which is to be transferred to a output device, in response to an instruction sent from a client, in a network connecting with said computer, the client and multiple output devices, said computer program causing the computer to attain the functions of:
receiving input of a master image and/or sound file according to the instruction sent from said client; and
converting the master image and/or sound file into the transfer file of a predetermined format, which does not depend upon said output device and carrying out encoding, which is kept from at least a user who gives the instruction, in the conversion process.

18. A computer readable recording medium in which a computer program is recorded, said computer program causing a computer to decode an encoded transfer file and transmit a decoded transfer file to an output device, in a network connecting with the computer, the client, and multiple output devices said computer program causing the computer to attain the functions of:
receiving input of intrinsic information, which is mapped to at least part of the instruction sent from said client and is utilized for encoding; and
carrying out decoding of said encoded transfer file with the input intrinsic information.
